(19) United States
(12) Patent Application Publication
(10) Pub. No.: US 2026/0112704 A1
(43) Pub. Date: Apr. 23, 2026

(54) ELECTROLYTE SOLUTION AND METAL BATTERY

(71) Applicant: Industrial Technology Research Institute, Hsinchu (TW)

(72) Inventors: Wei-Hsin Wu, Hsinchu City (TW); Yin-Cheng Yen, Hsinchu City (TW); Yi-Jen Wang, New Taipei City (TW); Deng-Tswen Shieh, Hsinchu City (TW)

(73) Assignee: Industrial Technology Research Institute, Hsinchu (TW)

(21) Appl. No.: 19/352,479

(22) Filed: Oct. 8, 2025

Related U.S. Application Data
(60) Provisional application No. 63/710,602, filed on Oct. 23, 2024.

(30) Foreign Application Priority Data
Jul. 24, 2025 (TW) 114128072

(51) Int. Cl. H01M 10/0568; H01M 10/052; H01M 10/0569

(52) U.S. Cl. CPC H01M 10/0568; H01M 10/052; H01M 10/0569; H01M 2300/0042

(57) ABSTRACT

An electrolyte solution and a metal battery are provided. The electrolyte solution includes a solvent, a first aggregate structure and a second aggregate structure. The first aggregate structure and the second aggregate structure respectively include cations and anions that are coordinated with each other and dissociated from a salt. In the first aggregate structure, the coordination number between a single one cation of the cations and the anions is 2, while in the second aggregate structure, the coordination number between a single one of the cations and the anions is 3 or more, and a ratio of a quantity of the second aggregate structure and a quantity of the first aggregate structure is equal to or greater than 1.

### CROSS-REFERENCE TO RELATED APPLICATION

The present application is based on, and claims priority from, U.S. Provisional Application Ser. No. 63/710,602, filed on Oct. 23, 2024, and Taiwan Application Serial Number 114128072, filed on Jul. 24, 2025, the disclosure of which is hereby incorporated by reference herein in its entirety.

### TECHNICAL FIELD

The present disclosure relates to an electrolyte solution and a metal battery.

### BACKGROUND

Lithium batteries have become the mainstream of commercial batteries and can be used in a variety of fields, including electric vehicles. In conventional lithium batteries, when lithium metal is used as the negative electrode, lithium metal corrosion is likely to occur on the solid electrolyte interface (SEI) formed at the interface between lithium metal and electrolyte after multiple charge and discharge cycles, which affects the cycle life and stability of the batteries. Therefore, there is still a need to provide lithium batteries with a solid electrolyte interface having corrosion resistance on the negative electrode surface for industry selection.

### SUMMARY

An electrolyte solution of the disclosure includes a solvent, a first aggregate structure, and a second aggregate structure. The first aggregate structure and the second aggregate structure respectively include cations and anions that are coordinated with each other and dissociated from a salt. In the first aggregate structure, the coordination number between a single one cation of the cations and the anions is 2, while in the second aggregate structure, the coordination number between a single one of the cations and the anions is 3 or more, and a ratio of a quantity of the second aggregate structure and a quantity of the first aggregate structure is ≥1.

A metal battery of the disclosure includes a positive electrode, a separator, a negative electrode, and the electrolyte solution as described above. The negative electrode is separated from the positive electrode by the separator. The electrolyte solution is disposed between the positive electrode and the negative electrode.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram of a metal battery according to an embodiment of the present disclosure.

FIG. 2 is a schematic diagram of a negative electrode according to an embodiment of the present disclosure.

FIG. 3 is a schematic diagram of a negative electrode according to another embodiment of the present disclosure.

FIG. 4 is a Raman spectrum of the electrolyte solution of Example 1.

FIG. 5 is a transmission electron microscope (TEM) image of the protective layer of Example 6.

FIG. 6 is a TEM image of the protective layer of Example 7.

FIG. 7 is a TEM image of the protective layer of Comparative Example 2.

FIG. 8 is a TEM image of the protective layer of Comparative Example 3.

### DETAILED DESCRIPTION OF DISCLOSED EMBODIMENTS

The disclosure may be understood by referring to the following detailed description and in collaboration with the accompanying drawings. It should be noted that, in order to make the readers easy to understand and for the concise of the drawings, the multiple drawings in the disclosure only draw a part of an electronic device, and certain elements in the drawings are not drawn to actual scales. In addition, the number and size of each component in the figures are only for illustration, and are not intended to limit the scope of the disclosure.

Directional terminology mentioned in the following embodiments, such as “top,” “bottom,” etc., is used with reference to the orientation of the FIG(s) being described and are not intended to limit the disclosure. In the FIGs, each of the drawings depicts typical features of methods, structures, and/or materials used in the particular exemplary embodiments. However, these drawings are not to be interpreted as limiting or limiting the scope or property covered by these exemplary embodiments. For example, for clarity, relative thickness and position of each film layer, region and/or structure may be reduced or enlarged.

When a corresponding component (for example, a film layer or an area) referred to be “on another component”, the component may be directly located on the another component, or other components probably exist there between. On the other hand, when a component is referred to be “directly on another component”, none other component exits there between. Moreover, when a component is referred to be “on another component”, the two components have an up-down relationship in a top view, and this component may be above or below another component, and the up-down relationship depends on an orientation of the device.

The terms “about”, “equal to”, “equivalent” or “identical”, “substantially” or “approximately” are generally interpreted as being within a range of 20% of a given value or range, or as being within a range of 10%, 5%, 3%, 2%, 1%, or 0.5% of the given value or range.

It should be noted that, in the following embodiments, the features of several different embodiments may be replaced, reorganized, and mixed to complete other embodiments without departing from the spirit of the disclosure. As long as the features of the various embodiments do not violate the spirit of the disclosure or conflict with each other, they may be mixed and matched arbitrarily.

In order to provide an electrolyte solution that forms, on the negative electrode, a protective layer having both good corrosion resistance to the electrolyte solution and good lithium utilization rate, the present disclosure proposes an electrolyte solution that can achieve the above advantages. In the following, specific embodiments are described as examples according to which the present disclosure can surely be implemented.

An electrolyte solution of an embodiment of the present disclosure includes a solvent, a first aggregate structure, and a second aggregate structure. In one embodiment, the electrolyte solution is suitable for use in a metal battery. Hereinafter, each of the above components will be described in detail.

The first aggregate structure and the second aggregate structure respectively include cations and anions that are coordinated with each other, and the cations and anions are formed by dissociation of a salt. According to one embodiment of the present disclosure, the solvent includes a solvating solvent and a non-solvating solvent. The solvating solvent can participate in dissolving the lithium salt, while the non-solvating solvent cannot participate in dissolving the lithium salt. Therefore, the non-solvating solvent may also be called a diluent.

Specifically, in the first aggregate structure, the coordination number between a single one cation of the cations and the anions is 2, while in the second aggregate structure, the coordination number between a single one cation of the cations and the anions is 3 or more (i.e., greater than or equal to 3). That is to say, in the first aggregate structure, a single one cation coordinates with two anions, while in the second aggregate structure, a single one cation coordinates with three or more anions. As a result, there is a stronger interaction or binding between the cations and the anions in the second aggregate structure than in the first aggregate structure.

Generally speaking, when a salt is dissolved, interactions occur between cations, anions, and a solvating solvent, so as to form a solvent-separated ion pair (SSIP), a contact ion pair (CIP), and an ion-pair aggregate depending on the degree of binding between the anions and the cations. Specifically, in the electrolyte solution of one embodiment of the present disclosure, the first aggregate structure is an ion-pair aggregate, and the second aggregate structure may be regarded as an ion-pair aggregate with more coordination. From another perspective, the electrolyte solution of one embodiment of the present disclosure includes not only the first aggregate structure and the second aggregate structure (i.e., ion-pair aggregates), but also solvent-separated ion pairs and contact ion pairs.

In the electrolyte solution of one embodiment of the present disclosure, the solvating solvent may act as a surfactant between the non-solvating solvent and the lithium salt, due to the miscibility of the solvating solvent and the non-solvating solvent, the solubility of the solvating solvent for the lithium salt, and the insolubility of the non-solvating solvent for the lithium salt. In this way, the solvating solvent and the lithium salt form salt-solvent clusters, and each salt-solvent cluster is surrounded by the non-solvating solvent, resulting in the existence of a plurality of sub-micro encapsulated structures in the electrolyte solution.

Furthermore, since the solvating solvent acts as a surfactant and accumulates at the interface between the lithium salt and the non-solvating solvent, the degree of binding between anions and cations in the salt-solvent cluster increases and tends to form a first aggregate structure and a second aggregate structure inside each sub-micro encapsulated structure, thereby resulting in a localized high-concentration electrolyte in the electrolyte solution. That is, in the electrolyte solution of one embodiment of the present disclosure, since the solvent includes a solvating solvent and a non-solvating solvent (i.e., a diluent), through the interactions between the lithium salt and the solvating solvent, as well as the interactions between the solvating solvent and the non-solvating solvent, result in the electrolyte solution including not only an ion-pair aggregate (i.e., the first aggregate structure) but also an ion-pair aggregate with greater coordination (i.e., the second aggregate structure), and the first aggregate structure and the second aggregate structure being locally distributed in the electrolyte solution.

On the other hand, since the cations and the anions in the second aggregate structure have a stronger degree of binding than those in the first aggregate structure, the second aggregate structure tends to aggregate at the center of the sub-micro encapsulated structure, while the first aggregate structure tends to be located closer to the outer shell of the sub-micro encapsulated structure, thereby naturally forming a salt concentration gradient in the sub-micro encapsulated structure.

According to one embodiment of the present disclosure, the ratio of the quantity of the second aggregate structure to the quantity of the first aggregate structure is ≥1. That is, in the electrolyte solution of one embodiment of the present disclosure, there may be a comparable amount of the second aggregate structure and the first aggregate structure, or there may be a tendency to form the second aggregate structure. In addition, according to one embodiment of the present disclosure, the ratio of the quantity of the solvent-separated ion pair to the quantity of the first aggregate structure is less than or equal to 0.2, and the ratio of the quantity of the contact ion pair to the quantity of the first aggregate structure is less than or equal to 0.5. That is, the components in the electrolyte solution of one embodiment of the present disclosure tend to be mainly the ion pair aggregate.

The ratio of the quantity of the solvent-separated ion pair, the quantity of the contact ion pair, and the quantity of the ion-pair aggregate (including the first aggregate structure and the second aggregate structure) in the electrolyte solution may be calculated by any method known to those having ordinary skill in the art. For example, the document of “Deciphering the Structure and Association Behavior in Aqueous Lithium Nitrate Solution (Journal of Raman Spectroscopy, 2025)” describes the ion coordination and aggregation behavior in the lithium nitrate aqueous solution, covering solution structure changes, micro-Raman spectroscopy observation results, and changes in the ratios of various ion pairs (i.e., solvent-separated ion pair, contact ion pair, and ion pair aggregate) with concentration. For example, the ratio of the quantity of the solvent-separated ion pair, the quantity of the contact ion pair, and the quantity of the ion-pair aggregate (including first and second aggregate structures) in the electrolyte solution may be calculated by using Raman spectroscopy. For example, in one embodiment where the lithium salt of the electrolyte solution is LiFSI, the solvating solvent of the electrolyte solution is DME, and the non-solvating solvent of the electrolyte solution is TTFE, the integral values of the peak of the solvent-separated ion pair (720±5 cm⁻¹), the peak of the contact ion pair (730±5 cm⁻¹), the peak of the first aggregate structure (745±5 cm⁻¹), and the peak of the second aggregate structure (755±5 cm⁻¹) in the Raman spectrum of the electrolyte solution are summed up as 100%, and the fraction of each component may be obtained. Then, the fraction of the second aggregate structure is divided by the fraction of the first aggregate structure to obtain the ratio of the quantity of the second aggregate structure to the quantity of the first aggregate structure, and so on.

On the other hand, in the sub-micro encapsulated structure, the interactions between the lithium salt and the solvating solvent, as well as the interactions between the solvating solvent and the non-solvating solvent, are temperature-sensitive and have different temperature dependencies, resulting in changes in the solvating solvent distribution and the local salt concentration at different operating temperatures. As a result, the ratio of the quantity of the solvent-separated ion pair, the quantity of the contact ion pair, and the quantity of the ion pair aggregate (including the first aggregate structure and the second aggregate structure) in the electrolyte solution may change at different operating temperatures.

It is worth noting that, through the electrolyte solution including the first aggregate structure with a coordination number of 2 between the single one cation of the cations and the anions and the second aggregate structure with a coordination number of 3 or more between the single one cation of the cations and the anions, with the ratio of the quantity of the second aggregate structure to the quantity of the first aggregate structure being ≥1, when the electrolyte solution is applied to the metal battery, the solid electrolyte interface (SEI) formed on the negative electrode surface after the electrolyte solution decomposes may include an amorphous inorganic compound layer and a plurality of crystalline lithium oxide particles dispersed in the amorphous inorganic compound layer. As a result, the negative electrode in the metal battery including the electrolyte solution can have both good corrosion resistance to the electrolyte solution and good lithium utilization rate, so that the metal battery can have good battery cycle life, capacity and stability.

According to one embodiment of the present disclosure, the salt includes a lithium salt. According to one embodiment of the present disclosure, the concentration of the lithium salt may be greater than or equal to about 1.5 M. For example, the concentration of the lithium salt may be about 1.5 M to 2 M. According to one embodiment of the present disclosure, the chemical formula of the lithium salt may be expressed as LiM, which forms a cation Li⁺ and anion M⁻ after dissociation. In some embodiments, the lithium salt may be a lithium salt containing an imide ion and a sulfonyl group, such as lithium bis(fluorosulfonyl)imide (LiFSI, LiN(FSO₂)₂), lithium bis(trifluoromethanesulfonyl)imide (LiTFSI, LiN(CF₃SO₂)₂), lithium bis(pentafluoroethanesulfonyl)imide (LiBETI, LiN(CF₃CF₂SO₂)₂), LiNSO₂CF₃SO₂F, LiNSO₂C₂FsSO₂F, LiNSO₂CF₂OCF₃SO₂F, LiNSO₂C₃HF₆SO₂F, LiNSO₂C₄F₉SO₂F, LiNSO₂C₅F₁₁SO₂F, LiNSO₂C₆F₁₃SO₂F, LiNSO₂C₇F₁₅SO₂F, LiNSO₂C₈F₁₇SO₂F, or LiNSO₂C₉F₁₉SO₂F. After dissociation, these lithium salts may form cations Li⁺ and anions N(FSO₂)₂⁻, N(CF₃SO₂)₂⁻, N(CF₃CF₂SO₂)₂⁻, NSO₂CF₃SO₂F⁻, NSO₂C₂FsSO₂F⁻, NSO₂CF₂OCF₃SO₂F⁻, NSO₂C₃HF₆SO₂F⁻, NSO₂C₄F₉SO₂F⁻, NSO₂C₅F₁₁SO₂F⁻, NSO₂C₆F₁₃SO₂F⁻, NSO₂C₇F₁₅SO₂F⁻, NSO₂C₈F₁₇SO₂F⁻, and NSO₂C₉F₁₉SO₂F⁻. That is, when the salt is a lithium salt, the cations in the first aggregate structure and the second aggregate structure may be lithium ions (Li⁺), and the anions in the first aggregate structure and the second aggregate structure may be N(FSO₂)₂⁻, N(CF₃SO₂)₂⁻, N(CF₃CF₂SO₂)₂⁻, NSO₂CF₃SO₂F⁻, NSO₂C₂FsSO₂F⁻, NSO₂CF₂OCF₃SO₂F⁻, NSO₂C₃HF₆SO₂F⁻, NSO₂C₄F₉SO₂F⁻, NSO₂C₅F₁₁SO₂F⁻, NSO₂C₆F₁₃SO₂F⁻, NSO₂C₇F₁₅SO₂F⁻, NSO₂C₈F₁₇SO₂F⁻, NSO₂C₉F₁₉SO₂F⁻, or a combination thereof. In some embodiments, the cations in the first aggregate structure and the second aggregate structure may be lithium ions (Li⁺), and the anions in the first aggregate structure and the second aggregate structure may be (FSO₂)₂N⁻, (CF₃SO₂)₂N⁻, (CF₃CF₂SO₂)₂N⁻, or combinations thereof.

According to one embodiment of the present disclosure, the aforementioned solvent may be an organic solvent, such as an ester solvent, a ketone solvent, a carbonate solvent, an ether solvent, an alkane solvent, an amide solvent, or a combination thereof. According to one embodiment of the present disclosure, the aforementioned solvating solvent may be 1,2-dimethoxyethane (DME), dipropyl ether (DPE), 1,2-dimethoxypropane (DMP), 1,2-diethoxyethane (DEE), dimethoxymethane (DMM), or a combination thereof. According to one embodiment of the present disclosure, the non-solvating solvent may be 1,1,2,2-tetrafluoroethyl-2,2,3,3-tetrafluoropropyl ether (TTFE), 1,2-Bis(1,1,2,2-tetrafluoroethoxy)ethane (TFEE), tris(2,2,2-trifluoroethyl) orthoformate (TFEO), bis(2,2,2-trifluoroethyl) ether (BTFE), 1H,1H,5H-octafluoropentyl 1,1,2,2-tetrafluoroethyl ether (OTE) or a combination thereof. In one embodiment, the molar ratio of the solvating solvent to the non-solvating solvent may be about 1:0.3 to 1:2.5. In one embodiment, the molar ratio of the lithium salt to the solvating solvent may be about 1:1 to 1:4. When the molar ratio of the solvating solvent to the non-solvating solvent, and the molar ratio of the lithium salt to the solvating solvent falls within the above ranges, it will be helpful to form the aforementioned ratio of the quantity of the second aggregate structure to the quantity of the first aggregate structure.

The present disclosure further provides a metal battery that utilizes any one electrolyte solution provided in the aforementioned embodiments. Therefore, the related descriptions of the electrolyte solution (i.e., the electrolyte solution 500) in the following embodiments will not be repeated.

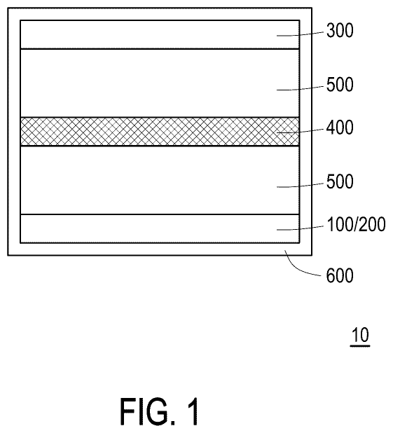

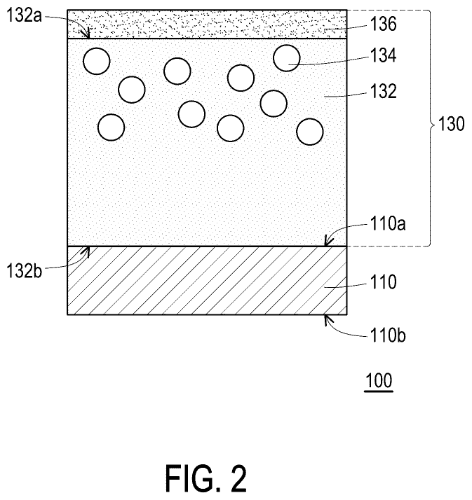

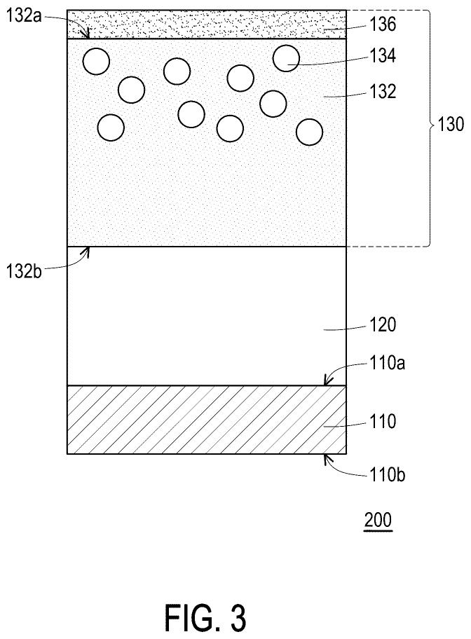

FIG. 1 is a schematic diagram of a metal battery according to an embodiment of the present disclosure. Referring to FIG. 1, the metal battery 10 includes a negative electrode 100 or a negative electrode 200 (as shown in FIG. 2 and FIG. 3), a separator 400, a positive electrode 300, and the electrolyte solution 500. In one embodiment, the metal battery 10 may further include a packaging structure 600. In addition, in one embodiment, the metal battery 10 is a lithium metal battery.

FIG. 2 is a schematic diagram of the negative electrode 100 according to an embodiment of the present disclosure. Referring to FIG. 2, the negative electrode 100 includes a substrate 110 and a protective layer 130.

In one embodiment, the substrate 110 is a current-collecting substrate. According to one embodiment of the present disclosure, the substrate 110 may include a metal foil. For example, the material of the substrate 110 may be aluminum, copper, nickel, aluminum-containing alloy, copper-containing alloy, nickel-containing alloy, stainless steel, or a combination thereof. According to one embodiment of the present disclosure, the aluminum-containing alloy is distinct from the copper-containing alloy, the nickel-containing alloy, or the stainless steel. According to one embodiment of the present disclosure, the copper-containing alloy is distinct from the aluminum-containing alloy, the nickel-containing alloy, or the stainless steel. According to one embodiment of the present disclosure, the nickel-containing alloy is distinct from the aluminum-containing alloy, the copper-containing alloy, or the stainless steel. According to one embodiment of the present disclosure, the stainless steel is distinct from the aluminum-containing alloy, the nickel-containing alloy, or the copper-containing alloy. The thickness of the substrate 110 is not limited and may be adjusted according to actual needs, and may be, for example, between 5 μm and 500 μm.

In one embodiment, the protective layer 130 is a solid electrolyte interface (SEI). That is, the protective layer 130 is a film layer formed after the decomposition of the electrolyte solution 500. In one embodiment, the protective layer 130 is disposed on the substrate 110. In detail, as shown in FIG. 2, the substrate 110 has a top surface 110a and a bottom surface 110b opposite to each other, and the protective layer 130 is disposed on the top surface 110a. In one embodiment, the thickness of the protective layer 130 is greater than about 10 nm. For example, the thickness of the protective layer 130 may be about 20 nm to about 500 nm, such as about 20 nm to about 400 nm, 20 nm to about 300 nm, or 20 nm to about 200 nm. Referring to FIG. 2, the protective layer 130 includes an amorphous inorganic compound layer 132 and a plurality of crystalline lithium oxide particles 134. In addition, in one embodiment, the protective layer 130 may further include an organic compound layer 136.

In one embodiment, the amorphous inorganic compound layer 132 is directly on the substrate 110. In detail, as shown in FIG. 2, the amorphous inorganic compound layer 132 has a top surface 132a and a bottom surface 132b opposite to each other, and the bottom surface 132b of the amorphous inorganic compound layer 132 is in direct contact with the top surface 110a of the substrate 110. In one embodiment, the amorphous inorganic compound layer 132 includes lithium oxide accounting for 90 wt % or more of the total weight of the amorphous inorganic compound layer 132. That is, the material of the amorphous inorganic compound layer 132 mainly includes amorphous lithium oxide. From another perspective, the product components after decomposition of the electrolyte solution 500 mainly include lithium oxide.

In one embodiment, the plurality of crystalline lithium oxide particles 134 are dispersed in the amorphous inorganic compound layer 132. Specifically, as shown in FIG. 2, the plurality of crystalline lithium oxide particles 134 are dispersed at a side of the amorphous inorganic compound layer 132 away from the substrate 110. From another point of view, the plurality of crystalline lithium oxide particles 134 dispersed in the amorphous inorganic compound layer 132 are adjacent to the top surface 132a of the amorphous inorganic compound layer 132 than to the bottom surface 132b of the amorphous inorganic compound layer 132. In one embodiment, the particle size of the crystalline lithium oxide particles 134 may be about 1 nm to about 100 nm, for example, about 1 nm to about 80 nm, about 1 nm to about 60 nm, or about 1 nm to about 40 nm. In one embodiment, the particle size of each crystalline lithium oxide particle 134 is about 1 nm to about 100 nm. In one embodiment, the crystalline lithium oxide particles 134 may have a crystal plane (111), a crystal plane (220), a crystal plane (311), a crystal plane (400), a crystal plane (422), a crystal plane (440), or a combination thereof. In one embodiment, each crystalline lithium oxide particle 134 has a crystal plane (111), a crystal plane (220), a crystal plane (311), a crystal plane (400), a crystal plane (422), or a crystal plane (440). In one embodiment, each of the crystalline lithium oxide particles 134 has a different crystal plane combinations. That is, the crystalline lithium oxide particles 134 may be polycrystalline lithium oxide particles. In one embodiment, the content of the crystalline lithium oxide particles in the amorphous inorganic compound layer may be at least about 0.1 wt %, for example, about 0.1 wt % to about 10 wt %, based on the total weight of the amorphous inorganic compound layer.

In one embodiment, the protective layer may further include an organic compound layer. In one embodiment, the organic compound layer 136 is disposed on the amorphous inorganic compound layer 132. In detail, as shown in FIG. 2, the organic compound layer 136 is directly contact the top surface 132a of the amorphous inorganic compound layer 132. In one embodiment, the organic compound layer 136 includes an oligomer. In detail, the oligomer may be a derivative obtained by decomposition of a solvent in the electrolyte solution in the metal battery including the negative electrode 100. For example, when the solvent of the electrolyte solution includes dimethyl ether (DME), the organic compound layer 136 may include polyethylene glycol oligomers derived from the decomposition and polycondensation of dimethyl ether.

It is worth noting that, the protective layer 130 includes the amorphous inorganic compound layer 132 and the plurality of crystalline lithium oxide particles 134 dispersed in the amorphous inorganic compound layer 132, and thus the negative electrode 100 can have both good corrosion resistance to the electrolyte solution and good lithium utilization rate, thereby enabling the metal battery 10 to have good battery cycle life, capacity, and stability. In addition, the protective layer 130 includes the organic compound layer 136, so that the protective layer 130 has a considerable degree of mechanical strength.

FIG. 3 is a schematic diagram of the negative electrode 200 according to another embodiment of the present disclosure. Please refer to FIG. 3 and FIG. 2, the negative electrode 200 in FIG. 3 is similar to the negative electrode 100 in FIG. 2. Therefore, the same or similar elements are represented by the same or similar numerals, and the related descriptions thereof may refer to the descriptions above and are thus omitted here. Hereinafter, the difference between the two embodiments will be described.

According to one embodiment of the present disclosure, the negative electrode may be further configured with an active material layer. In one embodiment, referring to FIG. 3, the negative electrode 200 includes an active material layer 120 disposed between a substrate 110 and the protective layer 130. Specifically, in one embodiment, the active material layer 120 is in direct contact with the top surface 110a of the substrate 110 and is in direct contact with the bottom surface 132b of the amorphous inorganic compound layer 132 in the protective layer 130. From another point of view, the active material layer 120 is directly on the top surface 110a of the substrate 110 and directly on the bottom surface 132b of the amorphous inorganic compound layer 132.

According to one embodiment of the present disclosure, the active material layer 120 includes lithium metal, a lithium-containing alloy, or a combination thereof. In addition, according to one embodiment of the present disclosure, the thickness of the active material layer 120 is not particularly limited, and a person skilled in the art may adjust the thickness according to actual needs. For example, the active material layer 120 may have a thickness of about 1 μm to about 1,000 μm (e.g., about 10 μm, 50 μm, 100 μm, 200 μm, 300 μm, 400 μm, 500 μm, 600 μm, 700 μm, 800 μm, or 900 μm).

According to one embodiment of the present disclosure, the positive electrode 300 may include a positive electrode active material. According to one embodiment of the present disclosure, the positive electrode active material includes elementary sulfur, organic sulfide, sulfur-carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or a combination thereof, and the metal is at least one selected from the group consisting of aluminum, vanadium, titanium, chromium, copper, molybdenum, niobium, iron, nickel, cobalt, and manganese. According to one embodiment of the present disclosure, the positive electrode active material may include or be lithium-cobalt oxide (LiCoO₂), lithium-nickel oxide (LiNiO₂), lithium-manganese oxide (LiMn₂O₄), lithium-manganese-cobalt oxide (LiMnCoO₄), lithium-cobalt-nickel-manganese oxide (LiCo_{0.3}Ni_{0.3}Mn_{0.3}O), lithium-cobalt phosphate (LiCoPO₄), lithium-manganese-chromium oxide (LiMnCrO₄), lithium-nickel-vanadium oxide (LiNiVO₄), lithium-manganese-nickel oxide (LiMn_{1.5}Ni_{0.5}O₄), lithium-cobalt-vanadium oxide (LiCoVO₄), or a combination thereof. In one embodiment, the positive electrode 300 may further include a conductive additive and a binder. The conductive additive and the binder may be conductive additives and binders commonly used in general batteries and are not particularly limited herein. For example, the conductive additive may include conductive carbon black, conductive graphite, fluorocarbon, reduced graphene, nitrogen-doped graphite, nitrogen-doped graphene, carbon fiber, carbon nanotubes, or a combination thereof. For example, the binder may include a fluorine-containing polymer. In addition, the binder may include, for example, polyvinyl alcohol, polytetrafluoroethylene, sodium carboxymethyl cellulose, polyvinylidene fluoride, styrene-butadiene copolymer, fluorinated rubber, polyurethane, polyvinylpyrrolidone, poly(ethyl acrylate), polyvinyl chloride, polyacrylonitrile, polybutadiene, poly(acrylic acid), or a combination thereof. According to one embodiment of the present disclosure, the positive electrode 300 may further include a positive electrode substrate (not shown), and the positive electrode active material is disposed on or in the positive electrode substrate. In one embodiment, the positive electrode substrate is a positive electrode current-collecting substrate. According to one embodiment of the present disclosure, the positive electrode 300 is composed of a positive electrode active material and a positive electrode substrate. According to one embodiment of the present disclosure, the positive electrode substrate may include a metal foil, such as copper foil, aluminum foil, carbon-coated aluminum foil, stainless steel foil, or other metal foils (such as platinum, titanium, etc.).

In one embodiment, as shown in FIG. 1, the negative electrode 100 or 200 is separated from the positive electrode 300 by the separator 400. The separator 400 may be a separator commonly used in general batteries and is not particularly limited here. According to one embodiment of the present disclosure, the separator 400 is made of insulating material, such as polyethylene (PE), polypropylene (PP), polytetrafluoroethylene film, polyamide film, polyvinyl chloride film, polyvinyl difluoride film, polyaniline film, polyimide film, polyethylene terephthalate (PET), polystyrene (PS), cellulose, or a combination thereof. For example, the separator 400 may be a porous film of a PE/PP/PE multi-layer composite structure. According to one embodiment of the present disclosure, the thickness of the separator 400 is not particularly limited, and a person skilled in the art can adjust the thickness according to actual needs. For example, the thickness of the separator 400 may be about 1 μm to about 1,000 μm (e.g., about 10 μm, 50 μm, 100 μm, 200 μm, 300 μm, 400 μm, 500 μm, 600 μm, 700 μm, 800 μm, or 900 μm). If the thickness of the separator 400 is too high (e.g., greater than 1,000 μm), the energy density of the battery is reduced. If the thickness of the separator 400 is too thin (e.g., less than 1 μm), the cycle stability of the battery is deteriorated.

In one embodiment, the electrolyte solution 500 is disposed between the positive electrode 300 and the negative electrode 100 or 200. In one embodiment, as shown in FIG. 1, the stacked structure of the negative electrode 100 or 200, the separator 400, and the positive electrode 300 is immersed in the electrolyte solution 500. In other words, the electrolyte solution 500 is dispersed throughout the metal battery 10. As previously described, the protective layer 130 in the negative electrode 100 or 200 is a film layer formed by decomposition of the electrolyte solution 500. Therefore, although not shown in the figure, a person skilled in the art will understand that compared to the substrate 110 in the negative electrode 100 or 200, the protective layer 130 in the negative electrode 100 or 200 is closer to the electrolyte solution 500, and compared to the amorphous inorganic compound layer 132 in the protective layer 130, the organic compound layer 136 in the protective layer 130 is closer to the electrolyte solution 500.

It is worth noting that the electrolyte solution 500 of the metal battery 10 includes any electrolyte solution proposed in the aforementioned embodiments, and the protective layer 130 in the negative electrode 100 or 200 includes the amorphous inorganic compound layer 132 and the plurality of crystalline lithium oxide particles 134 dispersed within the amorphous inorganic compound layer 132, so that the metal battery 10 can have good capacity, stability, and battery cycle life.

Hereinafter, the features of the present disclosure will be described in more detail with reference to Examples 1-17 and Comparative Examples 1-11. Although the following Examples 1 to 17 are described, the materials used, the amount and ratio of each thereof, as well as the detailed process flow, etc. can be suitably modified without departing from the scope of the present disclosure. Therefore, the scope of this disclosure should not be limited by the following embodiments.

### <Raman Spectroscopy Analysis of Electrolyte Solution>

### Example 1

2 mL of DME (solvating solvent) was mixed with 5 mL of TTFE (non-solvating solvent), and 2 g of LiFSI (lithium salt) was dissolved in the mixed solvent to form 1.5 M of the electrolyte solution of Example 1, wherein the molar ratio of LiFSI, DME, and TTFE is 1:1.5:3.

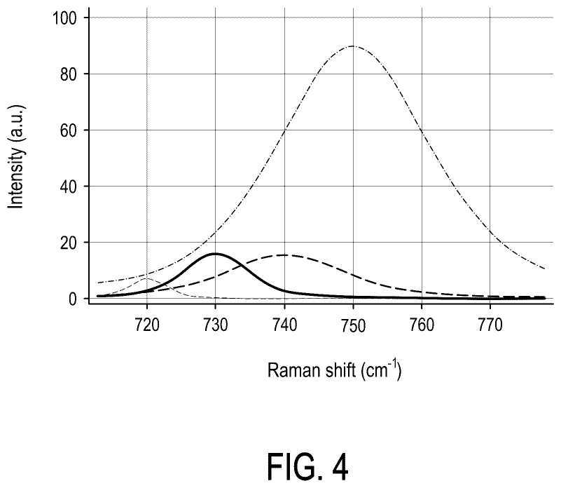

Next, the electrolyte solution of Example 1 was placed in a Raman spectrometer (UniDRON SR-GRT-1800) and Raman spectroscopy analysis was performed at 45° C. in the scanning range of 700 cm⁻¹ to 780 cm⁻¹ to obtain FIG. 4. Then, according to the spectrum shown in FIG. 4, the integrated values of the peak of the solvent-separated ion pair (720±5 cm⁻¹), the peak of the contact ion pair (730±5 cm⁻¹), the peak of the first aggregate structure (745±5 cm⁻¹), and the peak of the second aggregate structure (755±5 cm⁻¹) were summed up and considered as 100% to obtain the fraction of each component. The fraction of the second aggregate structure was then divided by the fraction of the first aggregate structure to obtain the ratio of the quantity of the second aggregate structure to the quantity of the first aggregate structure. The calculation results are shown in Table 1.

### Example 2

The electrolyte solution of Example 2 was prepared by the same preparation method as Example 1.

Next, the electrolyte solution of Example 2 was placed in a Raman spectrometer (UniDRON SR-GRT-1800) and Raman spectroscopy analysis was performed at 60° C. in the scanning range of 700 cm⁻¹ to 780 cm⁻¹. Then, the ratio of the quantity of the second aggregate structure to the quantity of the first aggregate structure was obtained using the same calculation method as in Example 1. The calculation results are shown in Table 1.

### Example 3

5 mL of DPE (solvating solvent) was mixed with 1.5 mL of TTFE (non-solvating solvent), and 2 g of LiFSI (lithium salt) was dissolved in the mixed solvent to form 1.5 M of the electrolyte solution of Example 3, wherein the molar ratio of LiFSI, DPE, and TTFE is 1:4:1.2.

Next, the electrolyte solution of Example 3 was placed in a Raman spectrometer (UniDRON SR-GRT-1800) and Raman spectroscopy analysis was performed at room temperature (i.e., 25° C.) in the scanning range of 700 cm⁻¹ to 780 cm⁻¹. Then, according to the calculation method of Example 1, the integrated values of the peaks of the solvent-separated ion pair (720±5 cm¹), the contact ion pair (730±5 cm¹), the first aggregate structure (745±5 cm¹), and the second aggregate structure (755±5 cm⁻¹) in the obtained Raman spectrum were summed up and considered as 100% to obtain the fraction of each component. The fraction of the second aggregate structure was then divided by the fraction of the first aggregate structure to obtain the ratio of the quantity of the second aggregate structure to the quantity of the first aggregate structure. The calculation results are shown in Table 1.

### Example 4

0.6 mL of DME (solvating solvent), 3 mL of DPE (solvating solvent) and 3 mL of TTFE (non-solvating solvent) were mixed, and 2 g of LiFSI (lithium salt) was dissolved in the mixed solvent to form 1.5 M of the electrolyte solution of Example 4, wherein the molar ratio of LiFSI, DME, DPE and TTFE is 1:0.5:2:2.

Next, the electrolyte solution of Example 4 was placed in a Raman spectrometer (UniDRON SR-GRT-1800) and Raman spectroscopy analysis was performed at room temperature (i.e., 25° C.) in the scanning range of 720 cm⁻¹ to 780 cm⁻¹. Then, according to the calculation method of Example 1, the integrated values of the peaks of the solvent-separated ion pair (720±5 cm⁻¹), the contact ion pair (730±5 cm⁻¹), the first aggregate structure (745±5 cm⁻¹), and the second aggregate structure (755±5 cm⁻¹) in the obtained Raman spectrum were summed up and considered as 100% to obtain the fraction of each component. The fraction of the second aggregate structure was then divided by the fraction of the first aggregate structure to obtain the ratio of the quantity of the second aggregate structure to the quantity of the first aggregate structure. The calculation results are shown in Table 1.

### Example 5

2 mL of DME (solvating solvent) was mixed with 5 mL of TFEE (non-solvating solvent), and 2 g of LiFSI (lithium salt) was dissolved in the mixed solvent to form 1.6 M of the electrolyte solution of Example 5, wherein the molar ratio of LiFSI, DME, and TFEE is 1:1.5:3.

Next, the electrolyte solution of Example 5 was placed in a Raman spectrometer (UniDRON SR-GRT-1800) and Raman spectroscopy analysis was performed at room temperature (i.e., 25° C.) in the scanning range of 700 cm⁻¹ to 780 cm⁻¹. Then, according to the calculation method of Example 1, the integrated values of the peaks of the solvent-separated ion pair (720±5 cm¹), the contact ion pair (730±5 cm⁻¹), the first aggregate structure (745±5 cm⁻¹), and the second aggregate structure (755±5 cm⁻¹) in the obtained Raman spectrum were summed up and considered as 100% to obtain the fraction of each component. The fraction of the second aggregate structure was then divided by the fraction of the first aggregate structure to obtain the ratio of the quantity of the second aggregate structure to the quantity of the first aggregate structure. The calculation results are shown in Table 1.

### Comparative Example 1

The electrolyte solution of Comparative Example 1 was prepared by the same preparation method as Example 1.

Next, the electrolyte solution of Comparative Example 1 was placed in a Raman spectrometer (UniDRON SR-GRT-1800) and Raman spectroscopy analysis was performed at room temperature (i.e., 25° C.) in the scanning range of 700 cm⁻¹ to 780 cm⁻¹. Then, the ratio of the quantity of the second aggregate structure to the quantity of the first aggregate structure was obtained using the same calculation method as in Example 1. The calculation results are shown in Table 1.

TABLE 1

| | operating | ratio of the quantity of the second |
|---|---|---|
| | temperature | aggregate structure to the quantity |
| | (° C.) | of the first aggregate structure |
| Example 1 | 45 | 3.68 |
| Example 2 | 60 | 2.54 |
| Example 3 | 25 | 1.38 |
| Example 4 | 25 | 1.44 |
| Example 5 | 25 | 2.09 |
| Comparative | 25 | 0.91 |
| Example 1 | | |

As shown in Table 1, after experiencing different operating temperatures (i.e., 45° C., 60° C., and 25° C.), the electrolyte solutions of Example 1, Example 2, and Comparative Example 1 with the same composition formula exhibit different composition ratios of the first aggregate structure and the second aggregate structure, wherein the ratio of the quantity of the second aggregate structure to the quantity of the first aggregate structure in each of the electrolyte solutions of Examples 1 and 2 is greater than 1, while the ratio of the quantity of the second aggregate structure to the quantity of the first aggregate structure in the electrolyte solution of Comparative Example 1 is less than 1. This result shows that the ratio of the quantity of the second aggregate structure to the quantity of the first aggregate structure in the electrolyte solution can be adjusted by changing temperature.

In addition, it can be seen from Table 1 that the electrolyte solutions of Examples 1 to 5 all formed the first aggregate structure and the second aggregate structure after being subjected to the operating temperature, and the ratio of the quantity of the second aggregate structure to the quantity of the first aggregate structure in each of the electrolyte solutions of Examples 1 to 5 is greater than 1. This result shows that through different composition formulas of the electrolyte solution, the first aggregate structure and the second aggregate structure in the electrolyte solution disclosed herein can still achieve a ratio of the quantity of the second aggregate structure to the quantity of the first aggregate structure of ≥1 even at room temperature (i.e., 25° C.).

Furthermore, batteries were assembled using the electrolyte solutions of Examples 1 to 5 and the electrolyte solution of Comparative Example 1 to test the stability of the batteries.

### <Aging Test—Lithium-Copper Asymmetric Battery>

### Example 1

Copper foil was used as the working electrode, lithium foil with a thickness of 200 m was used as the reference electrode, and Celgard 2320 (PP/PE/PP) was used as a separator to separate the working electrode from the reference electrode. Next, 75 μL of the electrolyte solution of Example 1 was added to wet the separator, and then a button-type battery CR2032 of Example 1 was formed after packaging.

Next, the battery of Example 1 was charged once at a temperature of 45° C. with a constant current density of 0.2 mA/cm², and then left to stand (i.e., without power supply) for 3 hours. Afterwards, the battery of Example 1 was discharged once at a temperature of 45° C. with a constant current density of 0.2 mA/cm² to a cut-off voltage of 1V, and the first coulombic efficiency of the battery of Example 1 was measured. The test results are shown in Table 2.

### Example 2

The manufacturing method of the battery of Example 1 was followed, except that the electrolyte solution of Example 2 was used, to obtain a button-type battery CR2032 of Example 2.

Next, the battery of Example 2 was charged once at a temperature of 60° C. with a constant current density of 0.2 mA/cm², and then left to stand (i.e., without power supply) for 3 hours. Afterwards, the battery of Example 2 was discharged once at a temperature of 60° C. with a constant current density of 0.2 mA/cm² to a cut-off voltage of 1V, and the first coulombic efficiency of the battery of Example 2 was measured. The test results are shown in Table 2.

### Example 3

The manufacturing method of the battery of Example 1 was followed, except that the electrolyte solution of Example 3 was used, to obtain a button-type battery CR2032 of Example 3.

Next, the battery of Example 3 was charged once at room temperature (i.e., 25° C.) with a constant current density of 0.2 mA/cm², and then left to stand (i.e., without power supply) for 3 hours. Afterwards, the battery of Example 3 was discharged once at room temperature (i.e., 25° C.) with a constant current density of 0.2 mA/cm² to a cut-off voltage of 1V, and the first coulombic efficiency of the battery of Example 3 was measured. The test results are shown in Table 2.

### Example 4

The manufacturing method of the battery of Example 1 was followed, except that the electrolyte solution of Example 4 was used, to obtain a button-type battery CR2032 of Example 4.

Next, the battery of Example 4 was charged once at room temperature (i.e., 25° C.) with a constant current density of 0.2 mA/cm², and then left to stand (i.e., without power supply) for 3 hours. Afterwards, the battery of Example 4 was discharged once at room temperature (i.e., 25° C.) with a constant current density of 0.2 mA/cm² to a cut-off voltage of 1V, and the first coulombic efficiency of the battery of Example 4 was measured. The test results are shown in Table 2.

### Example 5

The manufacturing method of the battery of Example 1 was followed, except that the electrolyte solution of Example 5 was used to obtain a button-type battery CR2032 of Example 5.

Next, the battery of Example 5 was charged once at room temperature (i.e., 25° C.) with a constant current density of 0.2 mA/cm², and then left to stand (i.e., without power supply) for 3 hours. Afterwards, the battery of Example 5 was discharged once at room temperature (i.e., 25° C.) with a constant current density of 0.2 mA/cm² to a cut-off voltage of 1V, and the first coulombic efficiency of the battery of Example 5 was measured. The test results are shown in Table 2.

### Comparative Example 1

The manufacturing method of the battery of Example 1 was followed, except that the electrolyte solution of Comparative Example 1 was used, to obtain a button-type battery CR2032 of Comparative Example 1.

Next, the battery of Comparative Example 1 was charged once at room temperature (i.e., 25° C.) with a constant current density of 0.2 mA/cm² and then left to stand (i.e., without power supply) for 3 hours. Afterwards, the battery of Comparative Example 1 was discharged once at room temperature (i.e., 25° C.) with a constant current density of 0.2 mA/cm² to a cut-off voltage of 1V, and the first coulombic efficiency of the battery of Comparative Example 1 was measured. The test results are shown in Table 2.

TABLE 2

| | operating | first |
|---|---|---|
| | temperature | coulombic |
| | (° C.) | efficiency (%) |
| Example 1 | 45 | 94.2 |
| Example 2 | 60 | 92.8 |
| Example 3 | 25 | 82.6 |
| Example 4 | 25 | 87.5 |
| Example 5 | 25 | 92.1 |
| Comparative | 25 | 82.5 |
| Example 1 | | |

As can be seen from Table 2, compared with the battery of Comparative Example 1, the batteries of Example 1 and Example 2 still have good first coulombic efficiency even after being left standing for a period of time. These results demonstrate that the electrolyte solution, comprising a first aggregate structure with a coordination number of 2 between a single one cation of cations and anions and a second aggregate structure with a coordination number of 3 or greater between a single one cation of cations and anions, with a ratio of the quantity of the second aggregate structure to the quantity of the first aggregate structure ≥1, can provide the battery's negative electrode with good corrosion resistance to the electrolyte solution and good lithium utilization rate, thereby resulting in good battery stability.

In addition, it can be seen from Table 2 that even after being left to stand for a period of time, the batteries of Example 3, Example 4 and Example 5 at the operating temperature of room temperature (i.e., 25° C.) still have good first coulombic efficiency. These results show that the electrolyte solution can be tailored to meet the needs of different battery applications by adjusting the composition formula to achieve a ratio of the quantity of the second aggregate structure to the quantity of the first aggregate structure ≥1.

### <Evaluation of Corrosion Resistance of Protective Layer—Lithium-Copper Asymmetric Battery>

### Example 6

Copper foil was used as the working electrode, lithium foil with a thickness of 200 m was used as the reference electrode, and Celgard 2320 (PP/PE/PP) was used as a separator to separate the working electrode from the reference electrode. The separator was wetted with 75 L of an electrolyte solution containing lithium salt LiFSI, a solvating solvent DME, and a non-solvating solvent TTFE (the molar ratio of LiFSI, DME, and TTFE was 1:1.5:3), and then a button-type battery CR2032 of Example 6 was formed after packaging.

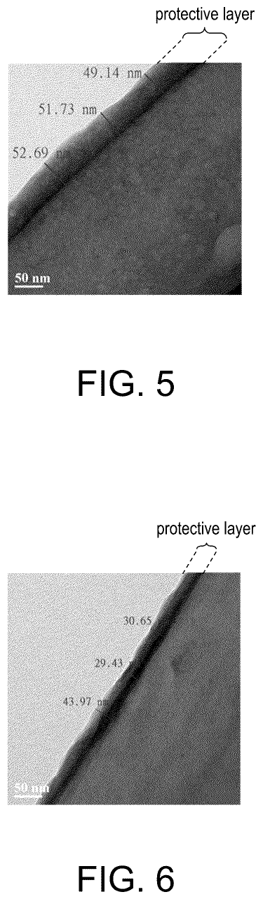

Next, the battery of Example 6 was charged once at a temperature of 60° C. with a constant current density of 0.2 mA/cm² to form a protective layer of Example 6 on the reference electrode. Next, the protective layer of Example 6 was photographed using a cryogenic transmission electron microscope (Cryo-TEM) to obtain FIG. 5; and Gatan digital micrograph developed by Gatan Corporation of the United States was used to collect images of the crystalline lithium oxide particles in the protective layer of Example 6 and analyze the images to measure their particle size. Test method: an image of the sample to be tested was generated by using the transmission electron microscopy, and then the distance from the start to the end of the contour to be measured in the image was measured, which is the particle size of the sample to be tested. The measurement results are shown in Table 3.

According to the test results of Example 2, the electrolyte solution in the battery of Example 6 includes the first aggregate structure and the second aggregate structure, and the ratio of the quantity of the second aggregate structure to the quantity of the first aggregate structure is 2.54.

### Example 7

The battery of Example 7 was prepared using the same preparation method as Example 6.

Next, the battery of Example 7 was charged once at a temperature of 60° C. with a constant current density of 0.2 mA/cm² to form a protective layer of Example 7 on the reference electrode. Next, after the battery having the protective layer of Example 7 was left to stand (i.e., without power supply) for 6 hours, the protective layer of Example 7 was photographed using a cryo-TEM to obtain FIG. 6; and Gatan digital micrograph developed by Gatan Corporation of the United States was also used to collect images of the crystalline lithium oxide particles in the protective layer of Example 7 and analyze the images to measure the particle size. The measurement results are shown in Table 3 below.

According to the test results of Example 2, the electrolyte solution in the battery of Example 7 includes the first aggregate structure and the second aggregate structure, and the ratio of the quantity of the second aggregate structure to the quantity of the first aggregate structure is 2.54.

### Comparative Example 2

The battery of Comparative Example 2 was prepared in the same manner as in Example 6.

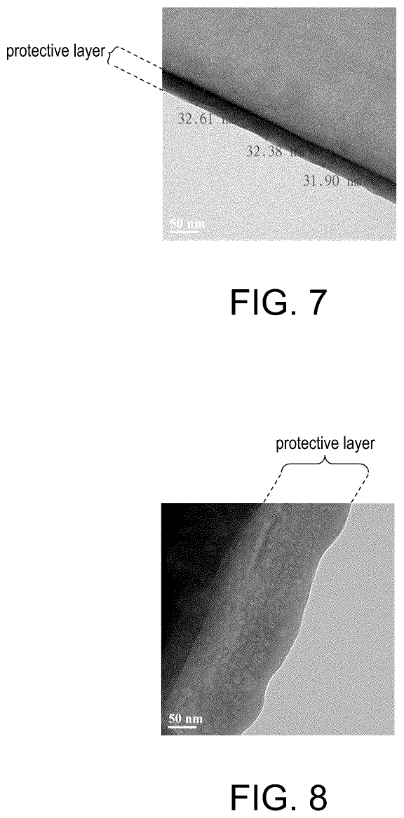

Next, the battery of Comparative Example 2 was charged once at room temperature (i.e., 25° C.) with a constant current density of 0.2 mA/cm² to form a protective layer of Comparative Example 2 on the reference electrode. The protective layer of Comparative Example 2 only includes the amorphous inorganic compound layer and the organic compound layer without forming crystalline lithium oxide particles. Next, the protective layer of Comparative Example 2 was photographed using a Cryo-TEM to obtain FIG. 7.

According to the test results of Comparative Example 1, the electrolyte solution in the battery of Comparative Example 2 includes the first aggregate structure and the second aggregate structure, and the ratio of the quantity of the second aggregate structure to the quantity of the first aggregate structure is 0.91.

### Comparative Example 3

The battery of Comparative Example 3 was prepared in the same manner as in Example 2.

Next, the battery of Comparative Example 3 was charged once at room temperature (i.e., 25° C.) with a constant current density of 0.2 mA/cm² to form a protective layer of Comparative Example 3 on the reference electrode. The protective layer of Comparative Example 3 only includes the amorphous inorganic compound layer and the organic compound layer without forming crystalline lithium oxide particles. Next, after the battery having the protective layer of Comparative Example 3 was left to stand (i.e., without power supply) for 6 hours, the protective layer of Comparative Example 3 was photographed using a Cryo-TEM, as shown in FIG. 8.

According to the test results of Comparative Example 1, the electrolyte solution in the battery of Comparative Example 3 includes the first aggregate structure and the second aggregate structure, and the ratio of the quantity of the second aggregate structure to the quantity of the first aggregate structure is 0.91.

TABLE 3

| | particle size (nm) |
|---|---|
| Example 6 | 6.1 |
| Example 7 | 6.1 |

The “particle size” in Table 3 refers to the average particle size of the crystalline lithium oxide particles in the amorphous inorganic compound layer.

FIG. 5 is a TEM image of the protective layer of Example 6. FIG. 6 is a TEM image of the protective layer of Example 7. FIG. 7 is a TEM image of the protective layer of Comparative Example 2. FIG. 8 is a TEM image of the protective layer of Comparative Example 3. As can be seen from FIG. 5 to FIG. 8 and Table 3, the protective layer of each of Examples 6 and 7, in which the ratio of the quantity of the second aggregate structure to the quantity of the first aggregate structure in the electrolyte solution is ≥1, has crystalline lithium oxide particles, while the protective layer of each of Comparative Examples 2 and 3, in which the ratio of the quantity of the second aggregate structure to the quantity of the first aggregate structure in the electrolyte solution is <1, lacks crystalline lithium oxide particles. These results demonstrate that by employing the electrolyte solution comprising a first aggregate structure with a coordination number of 2 between a single one cation of cations and anions and a second aggregate structure with a coordination number of 3 or greater between a single one cation of cations and anions, with a ratio of the quantity of the second aggregate structure to the quantity of the first aggregate structure being ≥1, a protective layer comprising an amorphous inorganic compound layer and a plurality of crystalline lithium oxide particles dispersed within the amorphous inorganic compound layer can be formed on a negative electrode of a battery.

Furthermore, as can be seen from FIG. 5 and FIG. 6, the thickness of the protective layer of Example 7 after standing for 6 hours (average thickness: about 41 nm) is not much different from the thickness of the protective layer of Example 6 without standing (average thickness: about 49 nm), indicating the high stability of the protective layer. It can be observed from FIG. 7 and FIG. 8 that the thickness of the protective layer of Comparative Example 3 after standing for 6 hours (average thickness: about 30 nm) changed greatly compared to the thickness of the protective layer of Comparative Example 2 without standing (average thickness: about 56 nm). This is because the protective layer formed after charging does not contain crystalline lithium oxide particles, the effect of isolating the electrolyte solution is weak, causing the interface between the protective layer and the electrode during the standing period to be continuously corroded and thus the reaction continuously undergo, resulting in a significant decrease in the thickness of the protective layer. These results show that the protective layer comprising a plurality of crystalline lithium oxide particles dispersed in an amorphous inorganic compound layer disclosed in the present disclosure can enable the negative electrode of the battery to have good corrosion resistance to electrolyte solution.

Furthermore, as can be seen from Table 3, the particle size of the crystalline lithium oxide particles of Example 7 after standing for 6 hours is almost unchanged compared to the particle size of the crystalline lithium oxide particles of Example 6 which has not been stood, indicating that the crystal stability is high. These results show that the protective layer disclosed herein, comprising a plurality of crystalline lithium oxide particles dispersed in an amorphous inorganic compound layer, can enable the negative electrode of the battery to have good corrosion resistance to electrolyte solution.

### <Cycle Life Test—Lithium-Copper Asymmetric Battery>

### Example 8

The battery of Example 8 was prepared using the same preparation method as Example 6.

Next, the battery of Example 8 was charged and discharged three times at a temperature of 60° C. with a constant current density of 0.2 mA/cm² to complete the battery formation process and form a protective layer of Example 8 on the reference electrode, and the protective layer of Example 8 includes crystalline lithium oxide particles dispersed in an amorphous inorganic compound layer. Next, the battery of Example 8 was subjected to charge and discharge cyclic at room temperature (i.e., 25° C.) and at a constant current density of 0.5 mA/cm², and the number of cycles of the battery of Example 8 when an internal short circuit occurs was measured. The test results are shown in Table 4.

According to the test results of Example 2, the electrolyte solution in the battery of Example 8 includes the first aggregate structure and the second aggregate structure, and the ratio of the quantity of the second aggregate structure to the quantity of the first aggregate structure is 2.54.

### Example 9

The battery of Example 9 was prepared using the same preparation method as Example 6.

Next, the battery of Example 9 was charged and discharged three times at a temperature of 60° C. with a constant current density of 0.4 mA/cm² to complete the battery formation process and form a protective layer of Example 9 on the reference electrode, and the protective layer of Example 9 includes crystalline lithium oxide particles dispersed in an amorphous inorganic compound layer. Next, the battery of Example 9 was subjected to charge and discharge cyclic at room temperature (i.e., 25° C.) and at a constant current density of 0.5 mA/cm², and the number of cycles of the battery of Example 9 when an internal short circuit occurs was measured. The test results are shown in Table 4.

According to the test results of Example 2, the electrolyte solution in the battery of Example 9 includes the first aggregate structure and the second aggregate structure, and the ratio of the quantity of the second aggregate structure to the quantity of the first aggregate structure is 2.54.

### Comparative Example 4

The battery of Comparative Example 4 was prepared in the same manner as in Example 6.

Next, the battery of Comparative Example 4 was charged and discharged three times at room temperature (i.e., 25° C.) with a constant current density of 0.2 mA/cm² to complete the battery formation process and form a protective layer of Comparative Example 4 on the reference electrode, and the protective layer of Comparative Example 4 only includes an amorphous inorganic compound layer and an organic compound layer without forming crystalline lithium oxide particles. Next, the battery of Comparative Example 4 was subjected to charge and discharge cyclic at room temperature (i.e., 25° C.) and at a constant current density of 0.5 mA/cm², and the number of cycles of the battery of Comparative Example 4 when an internal short circuit occurs was measured. The test results are shown in Table 4.

According to the test results of Comparative Example 1, the electrolyte solution in the battery of Comparative Example 4 includes the first aggregate structure and the second aggregate structure, and the ratio of the quantity of the second aggregate structure to the quantity of the first aggregate structure is 0.91.

### Comparative Example 5

The battery of Comparative Example 5 was prepared in the same manner as in Example 6.

Next, the battery of Comparative Example 5 was charged and discharged three times at room temperature (i.e., 25° C.) with a constant current density of 0.4 mA/cm² to complete the battery formation process and form a protective layer of Comparative Example 5 on the reference electrode, and the protective layer of Comparative Example 5 only includes an amorphous inorganic compound layer and an organic compound layer without forming crystalline lithium oxide particles. Next, the battery of Comparative Example 5 was subjected to charge and discharge cyclic at room temperature (i.e., 25° C.) and at a constant current density of 0.5 mA/cm², and the number of cycles of the battery of Comparative Example 5 when an internal short circuit occurs was measured. The test results are shown in Table 4.

According to the test results of Comparative Example 1, the electrolyte solution in the battery of Comparative Example 5 includes the first aggregate structure and the second aggregate structure, and the ratio of the quantity of the second aggregate structure to the quantity of the first aggregate structure is 0.91.

TABLE 4

| | the number of cycles when an |
|---|---|
| | internal short circuit occurs |
| Example 8 | 157 |
| Example 9 | 124 |
| Comparative | 58 |
| Example 4 | |
| Comparative | 77 |
| Example 5 | |

As can be seen from Table 4, the cycle life of the batteries of Examples 8 and 9 is better than the cycle life of the batteries of Comparative Examples 4 and 5. These results show that the protective layer comprising a plurality of crystalline lithium oxide particles dispersed in an amorphous inorganic compound layer disclosed herein can make the negative electrode of the battery have better stability, thereby enabling the battery to have a good cycle life.

### <Aging Test—Lithium-Copper Asymmetric Battery>

### Example 10

The battery of Example 10 was prepared using the same preparation method as Example 6.

Next, the battery of Example 10 was charged and discharged three times at a temperature of 60° C. with a constant current density of 0.2 mA/cm² to complete the battery formation process and form a protective layer of Example 10 on the reference electrode, and the protective layer of Example 10 includes crystalline lithium oxide particles dispersed in an amorphous inorganic compound layer. Next, the battery of Example 10 was charged once at a temperature of 60° C. with a constant current density of 0.2 mA/cm², and then left to stand (i.e., without power supply) for 3 hours. Afterwards, the battery of Example 10 was discharged once at a temperature of 60° C. with a constant current density of 0.2 mA/cm² to a cut-off voltage of 1V, and the first coulombic efficiency of the battery of Example 10 was measured. The test results are shown in Table 5.

According to the test results of Example 2, the electrolyte solution in the battery of Example 10 includes the first aggregate structure and the second aggregate structure, and the ratio of the quantity of the second aggregate structure to the quantity of the first aggregate structure is 2.54.

### Example 11

The battery of Example 11 was prepared in the same manner as in Example 6.

Next, the battery of Example 11 was charged and discharged three times at a temperature of 60° C. with a constant current density of 0.2 mA/cm² to complete the battery formation process and form a protective layer of Example 11 on the reference electrode, and the protective layer of Example 11 includes crystalline lithium oxide particles dispersed in an amorphous inorganic compound layer. Next, the battery of Example 11 was charged once at a temperature of 60° C. with a constant current density of 0.2 mA/cm², and then left to stand (i.e., without power supply) for 6 hours. Afterwards, the battery of Example 11 was discharged once at a temperature of 60° C. with a constant current density of 0.2 mA/cm² to a cut-off voltage of 1V, and the first coulombic efficiency of the battery of Example 11 was measured. The test results are shown in Table 5.

According to the test results of Example 2, the electrolyte solution in the battery of Example 11 includes the first aggregate structure and the second aggregate structure, and the ratio of the quantity of the second aggregate structure to the quantity of the first aggregate structure is 2.54.

### Comparative Example 6

The battery of Comparative Example 6 was prepared in the same manner as in Example 6.

Next, the battery of Comparative Example 6 was charged and discharged three times at room temperature (i.e., 25° C.) with a constant current density of 0.2 mA/cm² to complete the battery formation process and form a protective layer of Comparative Example 6 on the reference electrode, and the protective layer of Comparative Example 6 only includes an amorphous inorganic compound layer and an organic compound layer without forming crystalline lithium oxide particles. Next, the battery of Comparative Example 6 was charged once at room temperature (i.e., 25° C.) with a constant current density of 0.2 mA/cm² and then left to stand (i.e., without power supply) for 3 hours. Afterwards, the battery of Comparative Example 6 was discharged once at room temperature (i.e., 25° C.) with a constant current density of 0.2 mA/cm² to a cut-off voltage of 1V, and the first coulombic efficiency of the battery of Comparative Example 6 was measured. The test results are shown in Table 5.

According to the test results of Comparative Example 1, the electrolyte solution in the battery of Comparative Example 6 includes the first aggregate structure and the second aggregate structure, and the ratio of the quantity of the second aggregate structure to the quantity of the first aggregate structure is 0.91.

### Comparative Example 7

The battery of Comparative Example 7 was prepared in the same manner as in Example 6.

Next, the battery of Comparative Example 7 was charged and discharged three times at room temperature (i.e., 25° C.) with a constant current density of 0.2 mA/cm² to complete the battery formation process and form a protective layer of Comparative Example 7 on the reference electrode, and the protective layer of Comparative Example 7 only includes an amorphous inorganic compound layer and an organic compound layer without forming crystalline lithium oxide particles. Next, the battery of Comparative Example 7 was charged once at room temperature (i.e., 25° C.) with a constant current density of 0.2 mA/cm² and then left to stand (i.e., without power supply) for 6 hours. Afterwards, the battery of Comparative Example 7 was discharged once at room temperature (i.e., 25° C.) with a constant current density of 0.2 mA/cm² to a cut-off voltage of 1V, and the first coulombic efficiency of the battery of Comparative Example 7 was measured. The test results are shown in Table 5.

According to the test results of Comparative Example 1, the electrolyte solution in the battery of Comparative Example 7 includes the first aggregate structure and the second aggregate structure, and the ratio of the quantity of the second aggregate structure to the quantity of the first aggregate structure is 0.91.

TABLE 5

| | first coulombic |
|---|---|
| | efficiency (%) |
| Example 10 | 92.8 |
| Example 11 | 86.3 |
| Comparative | 82.5 |
| Example 6 | |
| Comparative | 48.0 |
| Example 7 | |

It can be seen from Table 5 that even after being left to stand for a period of time, the batteries of Example 10 and Example 11 still have good first coulombic efficiency. Moreover, the first coulombic efficiencies of the batteries of Examples 10 and 11 are both better than those of the batteries of Comparative Examples 6 and 7. These results show that the protective layer comprising a plurality of crystalline lithium oxide particles dispersed in an amorphous inorganic compound layer disclosed herein can make the negative electrode of the battery have good corrosion resistance to electrolyte solution and good lithium utilization rate, thereby providing good battery stability.

### <Capacity Retention Test—Lithium Metal Battery>

### Example 12

NMC622 (3.3 mAh/cm²) (purchased from Hunan Ruixiang) was used as the positive electrode active material, and aluminum foil (purchased from Sinosteel Aluminum) was used as the positive electrode current-collecting substrate. NMC622, conductive additives (carbon powder super-P, CNT) and binder (PVDF-HSV1800) were mixed evenly in a weight ratio of 96:1.4:0.6:2 to prepare an electrode slurry. The slurry was then coated on aluminum foil and dried to form a positive electrode. A lithium foil with a thickness of 20 m was used as the active material layer of the negative electrode, a copper foil (purchased from Bencheng Metal) was used as the current-collecting substrate of the negative electrode, and Celgard 2320 was used as a separator to separate the positive electrode from the negative electrode. After wetting the separator with 75 L of an electrolyte solution containing lithium salt LiFSI, a solvating solvent DME and a non-solvating solvent TTFE (the molar ratio of LiFSI, DME, and TTFE was 1:1.5:3), an aluminum-plastic film was used as a packaging structure for packaging to form a lithium metal battery of Example 12 (with an energy density of 350 Wh/kg).

Next, the lithium metal battery of Example 12 was subjected to a formation process to form a protective layer of Example 12 (comprising crystalline lithium oxide particles dispersed in an amorphous inorganic compound layer) on the lithium foil. One formation charge and discharge cycle includes steps of: at a temperature of 45° C., charging to 4.4V at a current of 0.1 C, stop charging when the constant voltage current is less than 0.01 C, and then discharging to 3.0V at a current of 0.1 C. After three formation charge and discharge cycles, the lithium metal battery of Example 12 was charged to 4.2V at a current of 0.1 C at room temperature (i.e., 25° C.), and then discharged at a current of 0.1 C to 3.0V to perform charge and discharge cycle measurement, and the capacitance retention rate and number of cycles were calculated. The test results are shown in Table 6 below.

According to the test results of Example 1, the electrolyte solution in the battery of Example 12 includes the first aggregate structure and the second aggregate structure, and the ratio of the quantity of the second aggregate structure to the quantity of the first aggregate structure is 3.68.

### Example 13

NMC811 (4.1 mAh/cm²) (purchased from RONBAY Technology) was used as the positive electrode active material, and aluminum foil (purchased from China Steel Aluminum Corporation) was used as the positive electrode current-collecting substrate. NMC811, conductive additives (carbon powder super-P, CNT) and binder (PVDF-HSV1800) were mixed evenly in a weight ratio of 96:1.4:0.6:2 to prepare an electrode slurry. The slurry was then coated on aluminum foil and dried to form a positive electrode. A copper foil (purchased from Bencheng Metal) was used as the current-collecting substrate for the negative electrode, and Celgard 2320 was used as a separator to separate the positive electrode from the negative electrode. After wetting the separator with 75 μL of an electrolyte solution containing lithium salt LiFSI, a solvating solvent DME, and a non-solvating solvent TTFE (the molar ratio of LiFSI, DME, and TTFE was 1:1.5:3), an aluminum-plastic film was used as a packaging structure for packaging to form a lithium metal battery of Example 13 (with an energy density of 400 Wh/kg).

Next, the lithium metal battery of Example 13 was subjected to a formation process to form a protective layer of Example 13 (comprising crystalline lithium oxide particles dispersed in an amorphous inorganic compound layer) on the copper foil. One formation charge and discharge cycle includes steps of: at a temperature of 45° C., charging to 4.4V at a current of 0.1 C, stop charging when the constant voltage current is less than 0.01 C, and then discharging to 3.6V at a current of 0.1 C. After three formation charge and discharge cycles, the lithium metal battery of Example 13 was charged to 4.3V at a current of 0.2 C at room temperature (i.e., 25° C.), and then discharged at a current of 0.2 C to 3.6V to perform charge and discharge cycle measurement, and the capacitance retention rate and the number of cycles were calculated. The test results are shown in Table 6 below.

According to the test results of Example 1, the electrolyte solution in the battery of Example 13 includes the first aggregate structure and the second aggregate structure, and the ratio of the quantity of the second aggregate structure to the quantity of the first aggregate structure is 3.68.

### Example 14

The lithium metal battery of Example 14 (with an energy density 400 of Wh/kg) was prepared according to the same preparation method as Example 13.

Next, the lithium metal battery of Example 14 was subjected to a formation process to form a protective layer of Example 14 (comprising crystalline lithium oxide particles dispersed in an amorphous inorganic compound layer) on the copper foil. One formation charge and discharge cycle includes steps of: at a temperature of 60° C., charging to 4.4V at a current of 0.1 C, stop charging when the constant voltage current is less than 0.01 C, and then discharging to 3.6V at a current of 0.1 C. After three formation charge and discharge cycles, the lithium metal battery of Example 14 was charged to 4.3V at a current of 0.2 C at room temperature (i.e., 25° C.), and then discharged to 3.6V at a current of 0.2 C to perform charge and discharge cycle measurement, and the capacitance retention rate and number of cycles were calculated. The test results are shown in Table 6 below.

According to the test results of Example 2, the electrolyte solution in the battery of Example 14 includes the first aggregate structure and the second aggregate structure, and the ratio of the quantity of the second aggregate structure to the quantity of the first aggregate structure is 2.54.

### Example 15

According to the preparation method of the lithium metal battery described in Example 13, except that a lithium foil with a thickness of 6.5 microns was used as the active material layer of the negative electrode to be formed on the copper foil (the current-collecting substrate of the negative electrode), to obtain a lithium metal battery of Example 15 (with an energy density of 400 Wh/kg).

Next, the lithium metal battery of Example 15 was subjected to a formation process to form a protective layer of Example 15 (comprising crystalline lithium oxide particles dispersed in an amorphous inorganic compound layer) on the lithium foil. One formation charge and discharge cycle includes steps of: at a temperature of 60° C., charging at a current of 0.1 C to 4.4V, stop charging when the constant voltage current is less than 0.01 C, and then discharging at a current of 0.1 C to 3.0V. After three formation charge and discharge cycles, the lithium metal battery of Example 15 was charged to 4.3V at a current of 0.2 C at room temperature (i.e., 25° C.), and then discharged to 3.0V at a current of 0.2 C to perform charge and discharge cycle measurement, and the capacitance retention rate and number of cycles were calculated. The test results are shown in Table 6 below.

According to the test results of Example 2, the electrolyte solution in the battery of Example 15 includes the first aggregate structure and the second aggregate structure, and the ratio of the quantity of the second aggregate structure to the quantity of the first aggregate structure is 2.54.

### Example 16

According to the preparation method of the lithium metal battery described in Example 13, except that a lithium foil with a thickness of 20 microns was used as the active material layer of the negative electrode to be formed on the copper foil (the current-collecting substrate of the negative electrode), to obtain the lithium metal battery of Example 16 (with an energy density of 400 Wh/kg).

Next, the lithium metal battery of Example 16 was subjected to a formation process to form a protective layer of Example 16 (comprising crystalline lithium oxide particles dispersed in an amorphous inorganic compound layer) on the lithium foil. One formation charge and discharge cycle includes steps of: at a temperature of 60° C., charging at a current of 0.05 C to 4.4V, stop charging when the constant voltage current is less than 0.01 C, and then discharging at a current of 0.05 C to 3.0V. After three formation charge and discharge cycles, the lithium metal battery of Example 16 was charged to 4.3V at a current of 0.2 C at room temperature (i.e., 25° C.), and then discharged at a current of 0.2 C to 3.0V to perform charge and discharge cycle measurement, and the capacitance retention rate and the number of cycles were calculated. The test results are shown in Table 6 below.

According to the test results of Example 2, the electrolyte solution in the battery of Example 16 includes the first aggregate structure and the second aggregate structure, and the ratio of the quantity of the second aggregate structure to the quantity of the first aggregate structure is 2.54.

### Example 17

The lithium metal battery of Example 17 (with an energy density of 400 Wh/kg) was prepared according to the same preparation method as Example 16.

Next, the lithium metal battery of Example 17 was subjected to a formation process to form the protective layer of Example 17 (comprising crystalline lithium oxide particles dispersed in an amorphous inorganic compound layer) on the lithium foil. One formation charge and discharge cycle includes steps of: at a temperature of 60° C., charging at a current of 0.1 C to 4.4V, stop charging when the constant voltage current is less than 0.01 C, and then discharging at a current of 0.1 C to 3.0V. After three formation charge and discharge cycles, the lithium metal battery of Example 17 was charged to 4.3V at a current of 0.2 C at room temperature (i.e., 25° C.), and then discharged at a current of 0.2 C to 3.0V to perform charge and discharge cycle measurement, and the capacitance retention rate and the number of cycles were calculated. The test results are shown in Table 6 below.

According to the test results of Example 2, the electrolyte solution in the battery of Example 17 includes the first aggregate structure and the second aggregate structure, and the ratio of the quantity of the second aggregate structure to the quantity of the first aggregate structure is 2.54.

### Comparative Example 8

The lithium metal battery of Comparative Example 8 (with an energy density of 350 Wh/kg) was prepared using the same preparation method as Example 12.

Next, the lithium metal battery of Comparative Example 8 was subjected to a formation process to form a protective layer of Comparative Example 8 (without the formation of crystalline lithium oxide particles) on the lithium foil. One formation charge and discharge cycle includes steps of: at room temperature (i.e., 25° C.), charging at a current of 0.1 C to 4.4V, stop charging when the constant voltage current is less than 0.01 C, and then discharging at a current of 0.1 C to 3.0V. After three formation charge and discharge cycles, the lithium metal battery of Comparative Example 8 was charged to 4.2V at a current of 0.1 C at room temperature (i.e., 25° C.), and then discharged at a current of 0.1 C to 3.0V to perform charge and discharge cycle measurement, and the capacitance retention rate and the number of cycles were calculated. The test results are shown in Table 6 below.

According to the test results of Comparative Example 1, the electrolyte solution in the battery of Comparative Example 8 includes the first aggregate structure and the second aggregate structure, and the ratio of the quantity of the second aggregate structure to the quantity of the first aggregate structure is 0.91.

### Comparative Example 9

The lithium metal battery of Comparative Example 9 (with an energy density of 400 Wh/kg) was prepared using the same preparation method as Example 13.

Next, the lithium metal battery of Comparative Example 9 was subjected to a formation process to form a protective layer of Comparative Example 9 (without the formation of crystalline lithium oxide particles) on the copper foil. One formation charge and discharge cycle includes steps of: at room temperature (i.e., 25° C.), charging at a current of 0.1 C to 4.4V, stop charging when the constant voltage current is less than 0.01 C, and then discharging at a current of 0.1 C to 3.6V. After three formation charge and discharge cycles, the lithium metal battery of Comparative Example 9 was charged to 4.3V at a current of 0.2 C at room temperature (i.e., 25° C.), and then discharged at a current of 0.2 C to 3.6V to perform charge and discharge cycle measurement, and the capacitance retention rate and the number of cycles were calculated. The test results are shown in Table 6 below.

According to the test results of Comparative Example 1, the electrolyte solution in the battery of Comparative Example 9 includes the first aggregate structure and the second aggregate structure, and the ratio of the quantity of the second aggregate structure to the quantity of the first aggregate structure is 0.91.

### Comparative Example 10

The lithium metal battery of Comparative Example 10 (with an energy density of 400 Wh/kg) was prepared according to the same preparation method as Example 15.

Next, the lithium metal battery of Comparative Example 10 was subjected to a formation process to form a protective layer of Comparative Example 10 ((without the formation of crystalline lithium oxide particles) on the lithium foil. One formation charge and discharge cycle includes steps of: at room temperature (i.e. 25° C.), charging to 4.4V at a current of 0.1 C until the constant voltage current is less than 0.01 C and then stop charging, then discharging to 3.0V with a current of 0.1 C. After three formation charge and discharge cycles, the lithium metal battery of Comparative Example 10 was charged to 4.3V at a current of 0.2 C at room temperature (i.e., 25° C.), and then discharged at a current of 0.2 C to 3.0V to perform charge and discharge cycle measurement, and the capacitance retention rate and the number of cycles were calculated. The test results are shown in Table 6 below.

According to the test results of Comparative Example 1, the electrolyte solution in the battery of Comparative Example 10 includes the first aggregate structure and the second aggregate structure, and the ratio of the quantity of the second aggregate structure to the quantity of the first aggregate structure is 0.91.

### Comparative Example 11

The lithium metal battery of Comparative Example 11 (with an energy density of 400 Wh/kg) was prepared using the same preparation method as Example 16.

Next, the lithium metal battery of Comparative Example 11 was subjected to a formation process to form a protective layer of Comparative Example 11 (without the formation of crystalline lithium oxide particles) on the lithium foil. One formation charge and discharge cycle includes steps of: at room temperature (i.e., 25° C.), charging to 4.4V at a current of 0.1 C until the constant voltage current is less than 0.01 C and then stop charging, then discharging to 3.0V with a current of 0.1 C. After three formation charge and discharge cycles, the lithium metal battery of Comparative Example 11 was charged to 4.3V at a current of 0.2 C at room temperature (i.e., 25° C.), and then discharged at a current of 0.2 C to 3.0V to perform charge and discharge cycle measurement, and the capacitance retention rate and the number of cycles were calculated. The test results are shown in Table 6 below.

According to the test results of Comparative Example 1, the electrolyte solution in the battery of Comparative Example 11 includes the first aggregate structure and the second aggregate structure, and the ratio of the quantity of the second aggregate structure to the quantity of the first aggregate structure is 0.91.

TABLE 6

| | capacitance retention |
|---|---|
| | rate (%)/number of cycles |
| Example 12 | 90%/710 |
| Example 13 | 80%/219 |
| Example 14 | 80%/305 |
| Example 15 | 80%/146 |
| Example 16 | 90%/384 |
| Example 17 | 90%/350 |
| Comparative | 80%/698 |
| Example 8 | |
| Comparative | 80%/103 |
| Example 9 | |
| Comparative | 80%/51 |
| Example 10 | |
| Comparative | 90%/309 |
| Example 11 | |

As shown in Table 6, compared to the lithium metal battery of Example 12, of which the capacitance retention rate is still 90% when the number of charge and discharge cycles reaches 710, the capacitance retention rate of the lithium metal battery of Comparative Example 8 has dropped to 80% when the number of charge and discharge cycles reaches 698, indicating that because the negative electrode of Comparative Example 8 lacks the crystalline lithium oxide particles described in the present disclosure, the stability of the protective layer is poor, resulting in a significantly faster battery performance degradation. Furthermore, it can be seen from Table 6 that compared to the lithium metal batteries of Examples 13 and 14, of which the capacitance retention rates drop to 80% when the numbers of charge and discharge cycles reach 219 and 305 respectively, the capacitance retention rate of the lithium metal battery of Comparative Example 9 has dropped to 80% when the number of charge and discharge cycles is only 103, indicating that because the negative electrode of Comparative Example 9 lacks the crystalline lithium oxide particles described in the present disclosure, the stability of the protective layer is poor, resulting in a significantly faster battery electrical degradation. Furthermore, it can be seen from Table 6 that, compared to the lithium metal battery of Example 15, of which the capacitance retention rate drops to 80% when the number of charge and discharge cycles reaches 146, the capacitance retention rate of the lithium metal battery of Comparative Example 10 has dropped to 80% when the number of charge and discharge cycles is only 51, indicating that because the negative electrode of Comparative Example 10 lacks the crystalline lithium oxide particles described in the present disclosure, the stability of the protective layer is poor, resulting in a significantly faster battery electrical degradation. Furthermore, it can be seen from Table 6 that, compared to the lithium metal batteries of Examples 16 and 17, of which the capacitance retention rate are 90% when the numbers of charge and discharge cycles reach 384 and 350 respectively, the capacitance retention rate of the lithium metal battery of Comparative Example 11 has dropped to 90% when the number of charge and discharge cycles is only the 309, indicating that because the negative electrode of Comparative Example 11 lacks the crystalline lithium oxide particles described in the present disclosure, the stability of the protective layer is poor, resulting in a significantly faster battery electrical degradation. These results demonstrate that the protective layer disclosed in the present disclosure includes a plurality of crystalline lithium oxide particles dispersed within an amorphous inorganic compound layer, it can make the negative electrode of the lithium metal battery have good corrosion resistance to electrolyte solution and good lithium utilization rate, thereby enabling the lithium metal battery to have good cycle life and stability.

In summary, by using the electrolyte solution comprising a first aggregate structure with a coordination number of 2 between a single one cation of cations and anions and a second aggregate structure with a coordination number of 3 or more between a single one cation of cations and anions, with a ratio of the quantity of the second aggregate structure to the quantity of the first aggregate structure being ≥1 disclosed in the present disclosure, a protective layer comprising an amorphous inorganic compound layer and a plurality of crystalline lithium oxide particles dispersed within the amorphous inorganic compound layer can be formed on a negative electrode of a metal battery. As a result, the negative electrode in the metal battery including the electrolyte solution can have both good corrosion resistance to electrolyte solution and good lithium utilization rate, so that the metal battery can have good battery cycle life, capacity and stability.

Although the present disclosure has been disclosed above in terms of implementation methods, this is not intended to limit the present disclosure. Anyone with ordinary skill in the art may make slight changes and modifications without departing from the spirit and scope of the present disclosure. Therefore, the scope of protection of the present disclosure shall be determined by the scope of the appended patent applications.

What is claimed is:

1. An electrolyte solution, comprising:
a solvent; and
a first aggregate structure and a second aggregate structure respectively including cations and anions coordinated with each other, wherein the cations and the anions are dissociated from a salt, a coordination number between a single one cation of the cations and the anions in the first aggregate structure is 2, a coordination number between a single one cation of the cations and the anions in the second aggregate structure is 3 or more, and a ratio of a quantity of the second aggregate structure to a quantity of the first aggregate structure is ≥1.

2. The electrolyte solution as claimed in claim 1, wherein the salt comprises a lithium salt, and a concentration of the lithium salt is ≥1.5M.

3. The electrolyte solution as claimed in claim 2, wherein the lithium salt is a lithium salt containing an imide ion and a sulfonyl group.

4. The electrolyte solution as claimed in claim 2, wherein the solvent comprises a solvating solvent and a non-solvating solvent.

5. The electrolyte solution as claimed in claim 4, wherein the solvating solvent includes 1,2-dimethoxyethane (DME), dipropyl ether (DPE), 1,2-dimethoxypropane (DMP), 1,2-diethoxyethane (DEE), dimethoxymethane (DMM), or a combination thereof.

6. The electrolyte solution as claimed in claim 4, wherein the non-solvating solvent includes 1,1,2,2-tetrafluoroethyl-2,2,3,3-tetrafluoropropyl ether (TTFE), 1,2-Bis(1,1,2,2-tetrafluoroethoxy)ethane (TFEE), tris(2,2,2-trifluoroethyl) orthoformate (TFEO), bis(2,2,2-trifluoroethyl) ether (BTFE), 1H,1H,5H-octafluoropentyl 1,1,2,2-tetrafluoroethyl ether (OTE) or a combination thereof.

7. The electrolyte solution as claimed in claim 4, wherein a molar ratio of the solvating solvent to the non-solvating solvent is 1:0.3 to 1:2.5.

8. The electrolyte solution as claimed in claim 4, wherein a molar ratio of the lithium salt to the solvating solvent is 1:1 to 1:4.

9. A metal battery, comprising:
a positive electrode;
a separator;
a negative electrode, separated from the positive electrode by the separator; and
an electrolyte solution disposed between the positive electrode and the negative electrode, wherein the electrolyte solution is the electrolyte solution as claimed in claim 1.

10. The metal battery as claimed in claim 9, wherein the negative electrode comprises:
a substrate; and
a protective layer disposed on the substrate, wherein the protective layer comprises:
an amorphous inorganic compound layer; and
a plurality of crystalline lithium oxide particles dispersed in the amorphous inorganic compound layer.

11. The metal battery as claimed in claim 9, further comprising a packaging structure covering the positive electrode, the separator, the negative electrode, and the electrolyte solution.
